(19) United States
(12) Patent Application Publication
(10) Pub. No.: US 2007/0074417 A1
(43) Pub. Date: Apr. 5, 2007

(54) Two-color ruler blade

(76) Inventor: Fu-Cheng Sun, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/242,037

(22) Filed: Oct. 4, 2005

(51) Int. Cl. G01B 3/10

(52) U.S. Cl. 33/755

(57) ABSTRACT

A two-color ruler blade utilized in a tape rule, the ruler blade fabricated of thin sheet steel that is cross-sectionally concave and radiused having a first color layer applied to the upper edge surface and a second color layer applied to the bottom edge surface. Tape rule graduations and numeric symbols are printed on the first color layer already applied to the upper edge surface of the ruler blade. As such, the first color layer and second color layer are each of a different color, resulting in a two-color steel tape rule, ruler blade.

### BACKGROUND OF THE INVENTION

1) Field of the Invention

The invention herein relates to a two-color ruler blade utilized in tape rules and wherein said ruler blade is fabricated of thin sheet steel that is cross-sectionally concave and radiused having a first color layer applied to its upper edge surface and a second color layer applied to its bottom edge surface. Tape rule graduations and numeric symbols are printed on the first color layer already applied to the upper edge surface of the ruler blade. As such, said first color layer and second color layer are each of a different color, resulting in a two-color steel tape rule, ruler blade.

2) Description of the Prior Art

As for prior art tape rule, ruler blades, referring to FIG. 1 and FIG. 2, said tape rule 10 ruler blade 11 is typically fabricated of thin sheet steel and has a concave surface of a certain radius to augment the degree of extension; a surface layer 12 having color is applied to the upper edge surface of the prior art steel, concave ruler blade 11 and a surface layer 13 having color is applied to the bottom edge surface 13 of the prior art steel, concave ruler blade 11, with the upper and lower surface layers 12 and 13 of the prior art ruler blade 11 each of identical color such that visual readability is difficult.

In view of the existent shortcomings of the prior art that still require solution, the inventor thought of an original idea that based on extensive professional and design experience gained while engaged in the relevant industrial fields culminated in the design of a two-color ruler blade

### SUMMARY OF THE INVENTION

The objective of the invention herein is to provide a two-color ruler blade, specifically a kind utilized for steel tape rules and in which said tape rule, ruler blade is cross-sectionally concave and radiused. A first color layer 22 is applied to the upper edge surface of the ruler blade and a second color layer 23 applied to the bottom edge surface the ruler blade and since said first color layer 22 and second color layer 23 are each of a different color, the result is a two-color steel tape rule, ruler blade.

To achieve said objective as well as enable a further understanding of the structure and functions of the most preferred embodiment of the invention herein, the brief description of the drawings is followed by the detailed description of the preferred embodiments.

### BRIEF DESCRIPTION OF THE DRAWINGS

FIG. 1 is an isometric drawing of the prior art product structure.

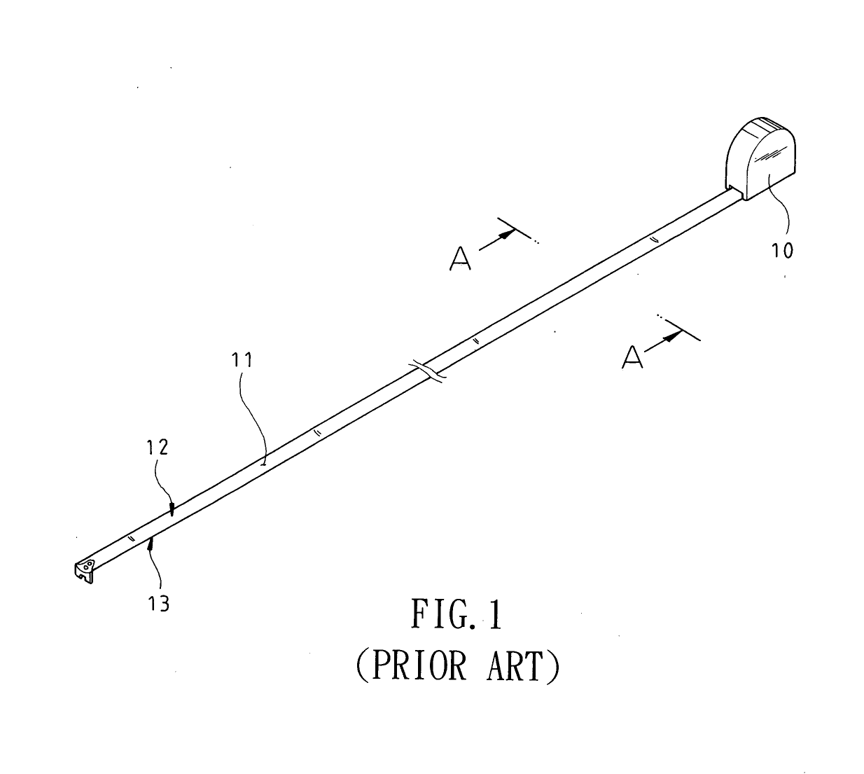

FIG. 2 is a cross-sectional drawing of the structure in FIG. 1, as viewed from the perspective of line A-A.

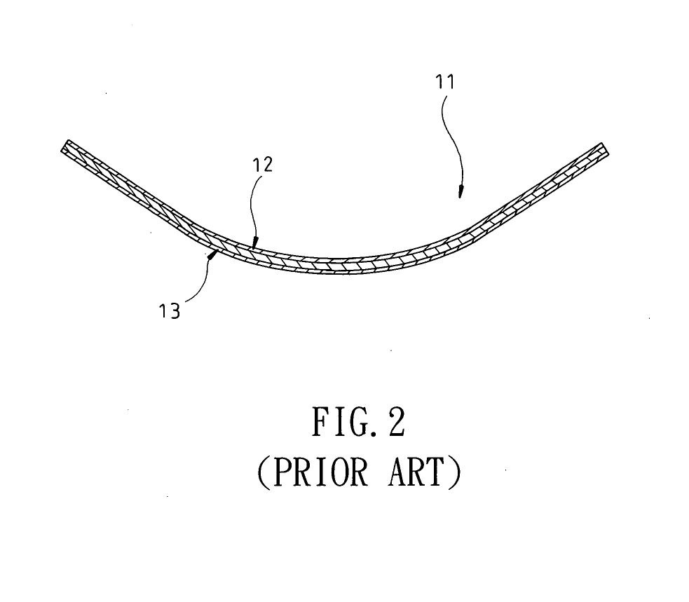

FIG. 3 is an isometric drawing of the invention herein.

FIG. 4 is a cross-sectional drawing of the structure in FIG. 3, as viewed from the perspective of line B-B.

### DETAILED DESCRIPTION OF THE PREFERRED EMBODIMENT

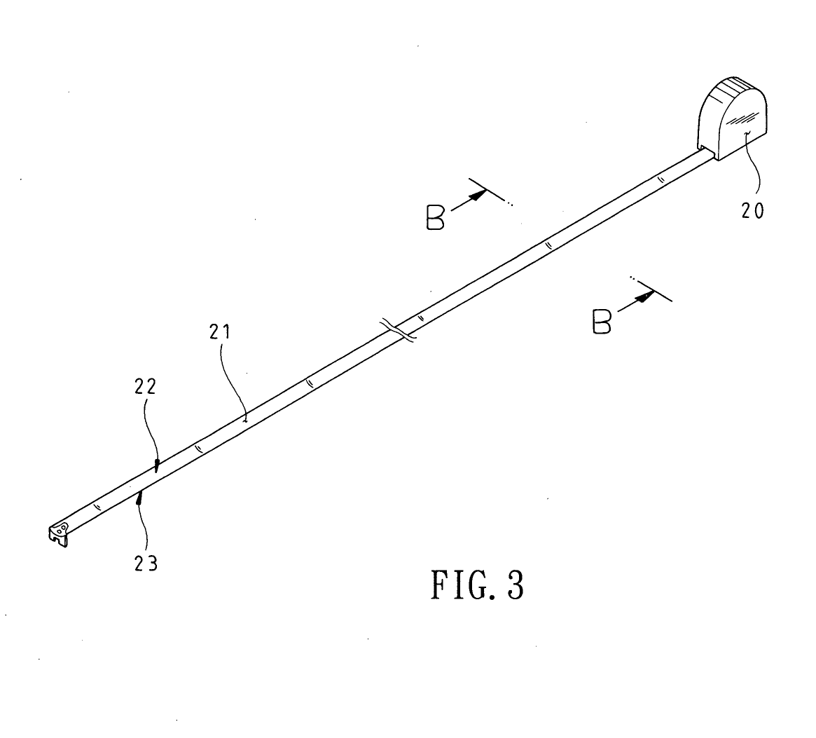

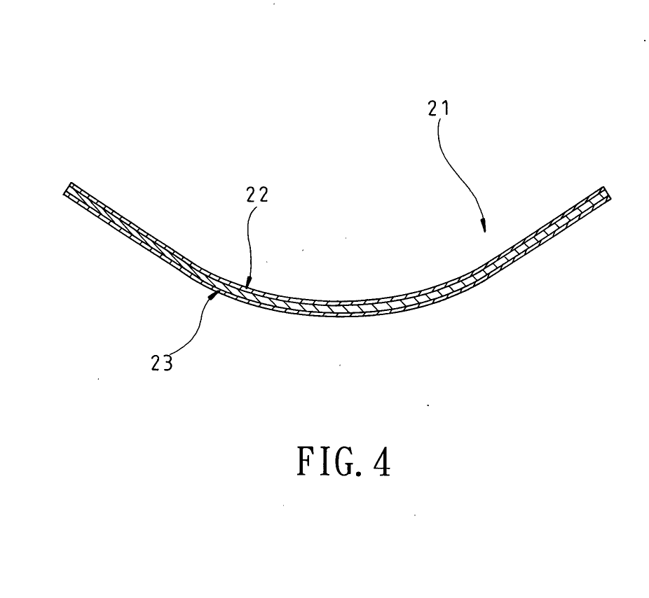

Referring first to FIG. 3 and FIG. 4, the invention herein consists of a ruler blade 21 utilized in a tape rule 20, said ruler blade 21 fabricated of thin sheet steel that is cross-sectionally concave and radiused having a first color layer 22 applied to its upper edge surface and a second color layer 23 applied to its bottom edge surface, with tape rule graduations and numeric symbols printed on the first color layer 22 already applied to the upper edge surface of the ruler blade 21, the improvement of which is: Said first color layer 22 and second color layer 23 are each of a different color, resulting in a two-color steel tape rule, ruler blade.

While said structure of the invention herein is capable of achieving the claimed utilization and functions, the description of said preferred embodiment of the present invention only serves to disclose the unique features of the invention herein and shall not be construed as a limitation on its scope and rights and, furthermore, all modifications and other adaptations shall belong to the claims of the invention herein.

In summation of the foregoing section, since the invention herein is not only of an improved spatial arrangement, capable of greater functionality and practical value and, furthermore, an identical or similar product has not been publicized in the market, the present invention meets new patent application requirements.

1. A two-color ruler blade utilized in a tape rule, said ruler blade fabricated of thin steel that is cross-sectionally concave and radiused having a first color layer applied to the upper edge surface and a second color layer applied to the bottom edge surface, with tape rule graduations and numeric symbols printed on said first color layer already applied to the upper edge surface of said ruler blade, the improvement of which is: said first color layer and said second color layer are each of a different color.
